(19) United States
(12) Patent Application Publication
(10) Pub. No.: US 2011/0298384 A1
(43) Pub. Date: Dec. 8, 2011

(54) LED DRIVING DEVICE AND ELECTRICAL APPARATUS USING THE SAME

(75) Inventors: Hiroyuki Tanigawa, Kyoto-shi (JP); Masaki Omi, Kyoto-shi (JP)

(73) Assignee: ROHM CO., LTD., Kyoto (JP)

(21) Appl. No.: 13/152,483

(22) Filed: Jun. 3, 2011

(30) Foreign Application Priority Data
Jun. 3, 2010 (JP) 2010-128218

(51) Int. Cl. G02F 1/133; H05B 37/02

(52) U.S. Cl. 315/209 R

(57) ABSTRACT

A LED driving device 200 includes a LED driving IC 100, an inductor L1, a diode D1, a capacitor C1, and a backlight BL. The LED driving IC 100 includes an output control circuit 10 which generates a switching signal SD to convert an input voltage VIN to an output voltage VOUT supplied to a LED. The output control circuit 10 also generates a feedback voltage VR based on a terminal voltage inputted from the LED (i.e., a feedback input voltage). The LED driving IC 100 also includes a switching pulse adjustment circuit 30 to generate a third control signal SB and to provide the signal to the output control circuit 10. The third control signal SB is an adjusted signal of an ON time of the first control signal SA, based on the second control signal SC and the feedback voltage VR. The LED driving IC 100 also includes a signal judgment part 20 to generate a second control signal SC based on the first control signal SA.

### CROSS-REFERENCE TO RELATED APPLICATIONS

This application claims the benefit of priority of Japanese patent application No. 2010-128218 (filing date: 2010 Jun. 3), which is incorporated herein by reference in its entirety.

### BACKGROUND OF THE INVENTION

1. Field of the Invention

This disclosure relates to a LED driving device to drive multiple LEDs connected in series, especially relates to a LED driving device which includes a switching regulator as a voltage source and drives LEDs by a PWM pulse, and especially relates to an electrical apparatus using the LED driving device.

2. Description of Related Art

A LED can be used as a backlight of an electrical apparatus such as a video camera, digital still camera, and a note type personal computer, for example. Also the LED is used as a light source, and a PWM signal is used for light control, for example. The PWM signal is used to control an illumination amount or a brightness of the LED constantly, and is provided separately from the switching regulator driven by the PWM signal. As a prior art of the LED driving device in accordance with the disclosure, a patent document is known described as below, for example.

Patent document 1 (Japanese patent publication No. 2005-45850) is related to a switching constant current power source device. For example, even if a current flowing through a load of a display including a LED intermits repeatedly (i.e., a current flows and a current does not flow), the switching constant current power source device is provided to stabilize a load current.

Patent document 2 (Japanese patent publication No. 2005-174725) discloses a LED driving circuit and a light control system, and so on.

Patent document 3 (Japanese patent publication No. 2007-295767) is related to a LED driving device to drive multiple LEDs connected in series and, in particular, is related to a LED driving device including a step up chopper regulator as a voltage source.

Patent document 4 (Japanese patent publication No. 2007-258459) discloses a LED backlight driving device to reduce the light adequately by PWM control.

Patent document 5 (Japanese paten publication No. 2008-53629) discloses a LED driving device which can drive a LED at a constant brightness whenever fluctuation of a power source voltage takes place.

With respect to a driving device to drive a LED by a PWM signal by using a switching regulator, the shorter the ON time of the PWM signal (e.g., a high level period of a pulse), the shorter the ON time of an output transistor. Thus, because of a shortage of the ON time of the supplied PWM signal relative to the required ON time to maintain an output voltage, an adequate ON time can not be obtained and the output voltage drops. Therefore, a defect occurs (i.e., an adequate voltage to drive the LED cannot be obtained).

### SUMMARY OF THE INVENTION

Therefore, in view of the aforementioned problems found by this applicant, the disclosure describes an LED driving device which can control an output voltage supplied to the LED without a voltage drop, even if the ON time of the PWM signal supplied to control brightness becomes shorter. The disclosure also describes an electrical apparatus using the LED driving device.

In some implementations, a LED driving device of the disclosure includes an output transistor to convert an inputted voltage to a predetermined output voltage and to supply the output voltage to a LED, a signal judgment part to generate a second control signal based on a first control signal of a PWM signal, a switching pulse adjustment circuit, and an output control circuit to generate a switching signal supplied to the output transistor based on the third control signal and the feedback voltage. The switching pulse adjustment circuit generates a third signal, which is an adjusted signal of the ON time of the first control signal, based on a feedback voltage according to a voltage drop of the LED, and based on the second control signal.

Other features of the disclosure, elements, steps, advantages, and characteristics will be apparent from the following description and the drawings.

### BRIEF DESCRIPTION OF THE DRAWINGS

FIG. 1 is a block diagram illustrating an embodiment of an electrical apparatus in accordance with the invention.

FIG. 2 is a circuit diagram illustrating a construction example of a LED driving device 200 in accordance with the invention.

FIG. 3 is a block diagram illustrating a construction example of a LED driving IC 100 in accordance with the invention.

FIG. 4 is a block diagram illustrating a construction example of a signal judgment part 20 in accordance with the invention.

FIG. 5 is a block diagram illustrating a construction example of a switching pulse adjustment part 33 in accordance with the invention.

FIG. 6 is a table illustrating a adjustment of ON time of a pulse by the switching pulse adjustment part 33.

FIG. 7 is a circuit diagram illustrating a construction example of a current driving circuit 50 in accordance with the invention.

FIG. 8 is a timing chart relates to a control of a LED driving device 200 in accordance with the invention.

### DETAILED DESCRIPTION OF PREFERRED EMBODIMENTS

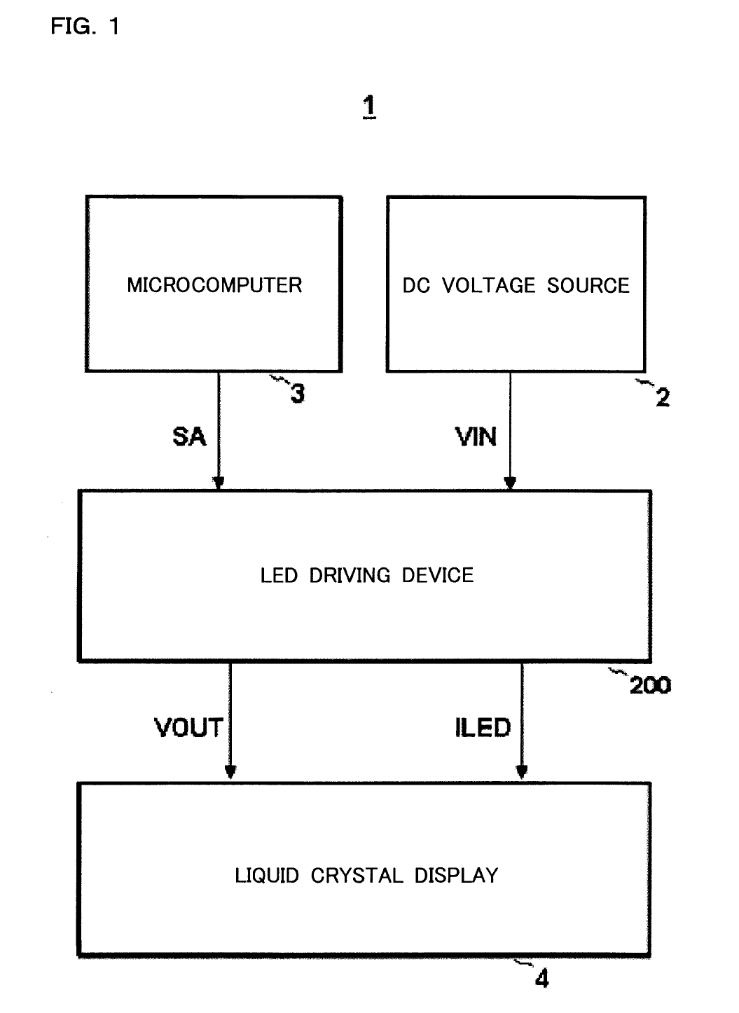

FIG. 1 is a block diagram illustrating an embodiment of an electrical apparatus in accordance with the disclosure. An electrical apparatus 1 includes a DC voltage source 2 (e.g., a battery), a microcomputer 3 to supply a control signal (e.g., a control signal to control brightness), a LED driving device 200 which operates in accordance with an output of the DC voltage source 2 and a control signal from the microcomputer 3, and a liquid crystal display 4 as displaying method of an electrical apparatus 1.

The LED driving device 200 generates a required output voltage VOUT and a LED driving current ILED based on an input voltage VIN applied from the DC voltage source 2 and the first control signal SA supplied from the microcomputer 3, then supplies the output voltage VOUT and the LED driving current ILED to the liquid crystal display 4 (i.e., a LED backlight provided for the liquid display 4). The first control signal SA is a PWM [Pulse Width Modulation] signal, and the frequency is set, for example, at 25 KHZ.

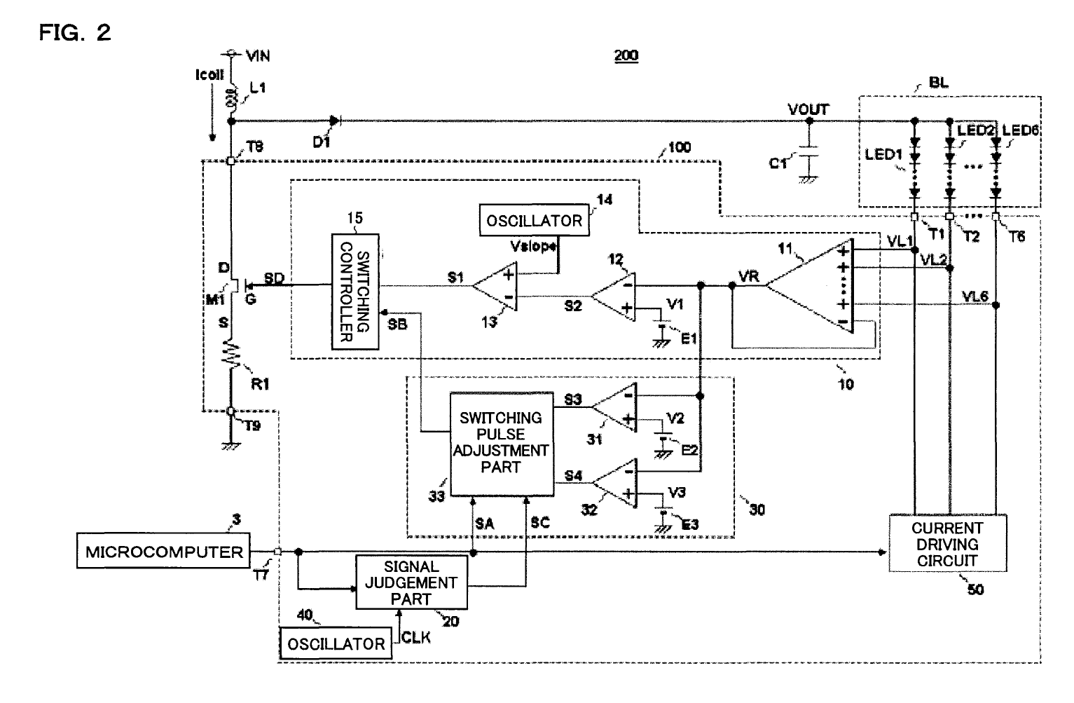

FIG. 2 is a circuit diagram illustrating a construction example of a LED driving device 200.

As illustrated in FIG. 2, the LED driving device 200 of the disclosure includes a step-up switching regulator (a chopper regulator) and a backlight BL. The step-up switching regulator includes an LED driving IC 100, an inductor L1, a diode D1 (a Schottky barrier diode), and a capacitor C1. The backlight BL is internally provided to the liquid display 4 illustrated in FIG. 1.

The LED driving IC 100 is implemented with a semiconductor IC, for example. To input or output several voltages or signals, external terminals T1 to T9 are provided to the LED driving IC 100. Generally, there are not negligible cases of a circuit part not illustrated in a diagram is internally provided to the LED driving IC 100. In this case, other external terminals except for the external terminals T1 to T9 are to be prepared.

The external terminals T1 to T6 are used, for example, to connect a backlight BL. The backlight BL is used, for example, for a note type personal computer. A light emitting diode row LED1 is connected to the external terminal T1. The light emitting diode row LED1 is constructed with ten light emitting diodes connected in series, for example. The construction of the connection is set arbitrary according to the implementation.

As with the external terminal T1, the light emitting diode rows LED2 to LED6 are connected to the external terminals T2 to T6. For convenience of illustration, the light emitting diode rows LED3 to LED5 are not described further.

The external terminal T7 is provided to receive a first control signal SA supplied from the microcomputer 3, for example. The first control signal SA is a PWM signal to control brightness of the light emitting diode rows LED1 to LED6.

The external terminal T8 is provided as a power source voltage supplying terminal of the LED driving IC 100.

The external terminal T9 is provided as a ground terminal of the LED driving IC 100.

The LED driving IC 100 includes an output control circuit 10, a signal judgment part 20, a switching pulse adjustment circuit 30, an oscillator 40, a current driving circuit 50, a resistor R1 and an output transistor M1 (N channel type field effect transistor). Apart from the aforementioned construction, a thermal protection circuit, for example, can be provided for the LED driving IC 100.

In the foregoing description, the resistor R1 and the output transistor M1 are equipped internally, however, in other cases they can be externally provided for the LED driving IC 100.

The output control circuit 10 is a measure to perform an ON-OFF control of the output transistor M1. The output control circuit 10 includes a buffer circuit 11, an error amplifier 12, a PWM [Pulse Width Modulation] comparator 13, an oscillator 14, and a switching controller 15. Thus, the output control circuit 10 operates with the inductor L1, the diode D1, the capacitor C1, the output transistor M1, and the resistor R1, then converts the input voltage VIN to the predetermined output voltage VOUT, and supplies the output voltage VOUT to the light emitting diode rows LED1 to LED6 constructed with multiple light emitting diodes. The buffer circuit 11 outputs the lowest voltage detected from the ground terminal T9) as a buffer voltage VR among the feed back voltages VL1 to VL6 of a connection node between the light emitting diode rows LED1 to LED6 and the current driving circuit 50 (i.e., among the voltages dropped from the output voltage VOUT by the light emitting diode rows LED1 to LED6). Then the buffer circuit 11 functions as a measure to control the output voltage VOUT for equalizing the buffer voltage VR to a predetermined reference voltage V1. Although the “buffer voltage” means an output voltage provided from the buffer circuit 11, the largest or the smallest voltage drop caused by among the light emitting diode rows LED1 to LED6 is practically equivalent to the buffer voltage VR practically. For example, if a voltage drop caused by the light emitting diode row LED1 is the largest among the light emitting diode rows LED1 to LED6, then the feedback voltage VL1 is the smallest detected from the ground terminal T9) among the feedback voltages VL1 to VL6, the buffer voltage VR becomes a voltage which is equivalent to the feedback voltage VL1. In case of detecting the smallest voltage drop among the light emitting diode rows LED1 to LED6, which can be realized by replacing a polarity of the non inverting input terminal (+) and the inverting input terminal (−) of the buffer circuit 11. In other words, this can be realized by connecting the feedback voltages VL1 to VL6 to the inverting input terminal (−) of the buffer circuit 11 respectively, and connecting the non inverting input terminal (+) and the output terminal of the buffer circuit 11 with each other.

The signal judgment part 20 is a measure to detect time of the first control signal SA maintained at a high level supplied from an external device (i.e., the microcomputer 3 is equipped with the LED driving device 200, externally), then judges a cycle of the first control signal SA based on the detected time, then turns ON or turns OFF the switching pulse adjustment circuit 30 based on the judgment. Thus, the signal judgment part 20 counts time of the high level period of the first control signal SA based on the clock signal CLK provided from the oscillator 40, then generates the second control signal SC to turn ON or turn OFF the switching pulse adjustment circuit 30 based on the counted time.

In the foregoing description, the signal judgment part 20 detects the time of the first control signal SA maintained at a high level to judge a cycle, whereas the signal judgment part 20 can judge the cycle by detecting the time of the first control signal SA maintained at a low level on behalf of the high level.

The switching pulse adjustment circuit 30 is a measure to adjust a duty ratio of the switching signal SD (i.e., the ON time of the output transistor M1) generated at the output control circuit 10. The switching pulse adjustment circuit 30 includes a first comparator 31, a second comparator 32, and the switching pulse adjustment part 33. Thus, among the feedback voltages VL1 to VL6 detected at connection nodes of between the light emitting diode rows LED1 to LED6 and the current driving circuit 50, the switching pulse adjustment circuit 30 compares the buffer voltage VR (i.e., VR is the lowest voltage of the feedback voltages VL1 to VL6 detected from the external ground terminal T9) with the DC voltage source E2 and the DC voltage source E3. Then the switching pulse adjustment circuit 30 adjusts a duty ratio of the switching signal SD based on the comparison result. In case of requiring the buffer circuit 11 is operated by the highest feedback voltage detected from the external terminal T9, as described above, which can be realized by replacing a polarity of the non inverting input terminal (+) and the inverting input terminal (−) of the buffer circuit 11.

The current driving circuit 50 supplies a predetermined driving current to the light emitting diode rows LED1 to LE6 based on the first control signal SA provided from an external device (e.g., the micro computer 3).

With respect to the LED driving device 200 illustrated in FIG. 2, a drain terminal D of the output transistor M1 is connected to an external terminal T8 (i.e., T8 is equivalent to an input terminal of the input voltage VIN) via the inductor L1, the inductance of which is several tens of microhenries. A source terminal S of the output transistor M1 is connected to the ground terminal T9 via the resistor R1, the resistance of which is several tens of milliohms. An anode terminal of the diode D1 is connected to the external terminal T8, and the cathode terminal of the diode D1 is connected to one end of the capacitor C1, the capacitance of which is several microfarads. The cathode of the diode D1 is also connected to anode terminals of the light emitting diode rows LED1 to LED6 constructing a backlight BL of the liquid crystal display 4, as an output terminal of the output voltage VOUT. The other end of the capacitor C1 is connected to the ground terminal T9.

With respect to the output control circuit 10, a non inverting input terminal (+) of the PWM comparator 13 is connected to an output terminal of the oscillator 14. An inverting input terminal (−) of the PWM comparator 13 is connected to an output terminal of the error amplifier 12. A non inverting input terminal (+) of the error amplifier 12 is connected to an applying terminal of the DC voltage source E1. The applying terminal of the DC voltage source E1 is equivalent to an output terminal of a bandgap power source circuit which is insensitive to alternation of an ambient temperature. An inverting input terminal (−) of the error amplifier 12 is connected to an output terminal of the buffer circuit 11. The first to sixth inverting input terminals of the buffer circuit 11 are connected to cathode terminals of the light emitting diode rows LED1 to LED6 via the terminals T1 to T6, respectively. An inverting input terminal (−) of the buffer circuit 11 is connected to an output terminal of the buffer circuit 11. The third control signal SB from the switching pulse adjustment circuit 30 and the PWM signal S1 from the PWM comparator 13 are provided to the switching controller 15. An output terminal of the switching controller 15 is connected to a gate terminal G of the output transistor M1.

A wave form provided from an output terminal of the oscillator 14 is not restricted to a triangle wave form, a saw tooth wave form can be used. The buffer circuit 11 is not restricted to a construction which has multiple non inverting input terminals (+), a construction which has only one non inverting input terminal (+) can be used. In this construction, the buffer voltage VR generated by the buffer circuit 11 approximately equals to a voltage applied to the non inverting input terminal (+).

The first control signal SA provided from an external device (e.g., the microcomputer 3) and the clock signal CLK provided from the oscillator 40 are provided to the signal judgment part 20.

With respect to the switching pulse adjustment circuit 30, an inverting input terminal (−) of the first comparator 31 is connected to an output terminal of the buffer circuit 11. A non inverting input terminal (+) of the first comparator 31 is connected to an applying terminal of the DC voltage source E2. The applying terminal of the DC voltage source E2 is equivalent to an output terminal of a bandgap power source circuit which is insensitive to an alternation of an ambient temperature. An inverting input terminal (−) of the second comparator 32 is connected to the output terminal of the buffer circuit 11. A non inverting input terminal (+) of the second comparator 32 is connected to an applying terminal of the DC voltage source E3. The applying terminal of the DC voltage source E3 is also equivalent to an output terminal of a bandgap power source circuit which is insensitive to an alternation of an ambient temperature. The output signal S3 from the first comparator 31, the output signal S4 from the second comparator 32, the first control signal SA from an external device (e.g., the microcomputer 3), and the second control signal SC from the signal judgment part 20 are provided to the switching pulse adjustment part 33.

With respect to the current driving circuit 50, the cathodes of the light emitting diode rows LED1 to LED6 are connected to the current driving circuit 50 via external terminals T1 to T6 (T3 to T5 are not illustrated). The first control signal SA is also provided from an external device (e.g., the microcomputer 3) to the current driving circuit 50.

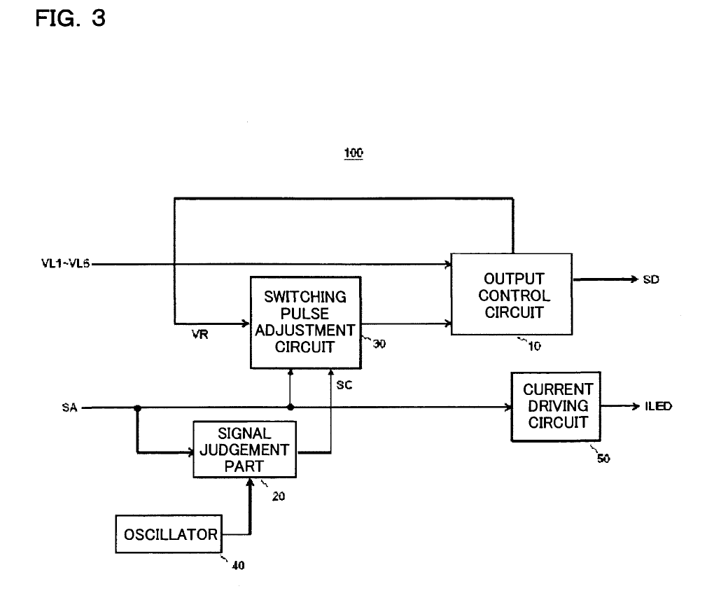

FIG. 3 is a block diagram illustrating a connecting relationship among the circuit elements of the LED driving IC 100. Explanations for each blocks are omitted because most of the explanations are the same as the aforementioned construction. In FIG. 2, the resistor R1 and the output transistor M1 are included at the LED driving IC 100, these are not illustrated in FIG. 3. The output control circuit 10, the signal judgment part 20, the switching pulse adjustment circuit 30, the oscillator 40, and the current driving circuit 50 are illustrated in FIG. 3. This construction can be applied if the resistor R1 and the output transistor M1 are provided outside of the LED driving IC 100.

The first control signal SA provided from an external device (e.g., the microcomputer 3) and the feedback voltages VL1 to VL6 provided from the light emitting diode rows LED1 to LED6 (i.e., the LED1 to LED6 constructs a backlight BL of the liquid crystal display 4) are provided to the LED driving IC 100 as a signal and voltages. The switching signal SD provided from the output control circuit 10 and the driving current ILED to drive the light emitting diode rows LED1 to LED6 provided from the current driving circuit 50 are provided from the LED driving IC 100 as an output signal or currents.

As with the signals provided to the switching pulse adjustment circuit 30 and the signal judgment part 20, the first control signal SA is provided to the current driving circuit 50, whereas a control signal different from the first control signal SA can be used.

The output transistor M1 is an output power transistor, ON-OFF control of which is controlled based on the switching signal SD provided from the switching controller 15. Although the output transistor M1 is illustrated as a NMOS transistor, a PMOS transistor can be used. Also a NPN bipolar transistor or a PNP bipolar transistor can be used on behalf of a MOS transistor.

If the output transistor M1 is turned ON, a coil current Icoil to the external terminal T9 (T9 is a ground terminal) via the output transistor M1 flows through the inductor L1, and an electrical energy is accumulated. If an electric charge is already charged to the capacitor C1 during ON period of the output transistor M1, a current from the capacitor C1 is supposed to flows through the light emitting diode rows LED1 to LED6 equipped as a load. At this time, an anode electric potential of the diode D1 drops approximately to the ground electrical potential via the output transistor M1, the diode D1 becomes a reverse biased state, and thus a current does not flow from the capacitor C1 to the output transistor M1.

On the other hand, if the output transistor M1 is turned OFF, an accumulated electrical energy accumulated at the inductor L1 is discharged because of a back electromotive voltage generated at the inductor L1. At this time, the diode D1 becomes an forward biased state, a current flowing through the diode D1 flows to the light emitting diode rows LED1 to LED6, and flows to the external terminal T9 (T9 is a ground terminal) via the capacitor C1, thus the capacitor C1 is charged. By repeating the aforementioned operation, an output voltage VOUT (VOUT is a DC voltage), stepped up and smoothed by the capacitor C1 are provided to the light emitting diode rows LED1 to LED6 equipped as a load.

Thus, the LED driving IC 100 of this embodiment operates as a construction element of a chopper regulator which outputs an output voltage VOUT by stepping up an input voltage VIN, by driving the inductor L1 (L1 is an energy accumulating element) according to ON-OFF control of the output transistor M1.

With respect to the buffer circuit 11 of the output control circuit 10 in FIG. 2, the feedback voltages VL1 to VL6 derived respectively from cathode terminals of the light emitting diode rows LED1 to LED6 is equivalent to voltages that are reduced across by the light emitting diode rows LED1 to LED6 from the output voltage VOUT, then outputs the lowest voltage among the feedback voltage VL1 to VL6 detected from the external terminal T9 (T9 is a ground terminal) as the buffer voltage VR.

In addition, although multiple cathode terminals of the diode rows LED1 to LED6 are inputted to the buffer circuit 10, a construction to which only one light emitting diode row is connected also can be used. In that case, the buffer circuit 10 provides the buffer voltage VR based on a feedback voltage which equals to a voltage that is reduced across the light emitting diode row from the output voltage VOUT.

The error amplifier 12 generates an error voltage S2 by amplifying a difference between the buffer voltage VR provided from the buffer circuit 11 and the predetermined reference voltage V1 applied to a non inverting input terminal of the error amplifier 12.

The PWM comparator 13 generates the PWM signal S1 by comparing a slope voltage Vslope applied to a non inverting input terminal (+) with an error voltage S2 applied to an inverting input terminal (−) (i.e., the duty ratio of the PWM signal S1 is based on the comparison). Thus, a logic level of the PWM signal S1 becomes a low level if the error voltage S2 is higher than a slope voltage Vslope, and becomes a high level if the error voltage S2 is lower than the slope voltage Vslope.

The switching controller 15 generates the switching signal SD based on the PWM signal S1 and the third control signal SB provided from the switching pulse adjustment circuit 30, then supplies the switching signal SD to a gate terminal G of the output transistor M1. The switching controller 15 maintains the switching signal SD as a high level if both of the PWM signal 51 and the third control signal SB provided to the switching transistor 15 are at a high level. Therefore, the output transistor M1 is turned ON if both of them are at a high level. On the other hand, while one of the PWM signal S1 and the third control signal SB is set at a low level, the switching signal SD is maintained at a low level. Thus the output transistor M1 is turned OFF.

As an implementation of the switching controller 15, a logic multiplication circuit can be used, for example.

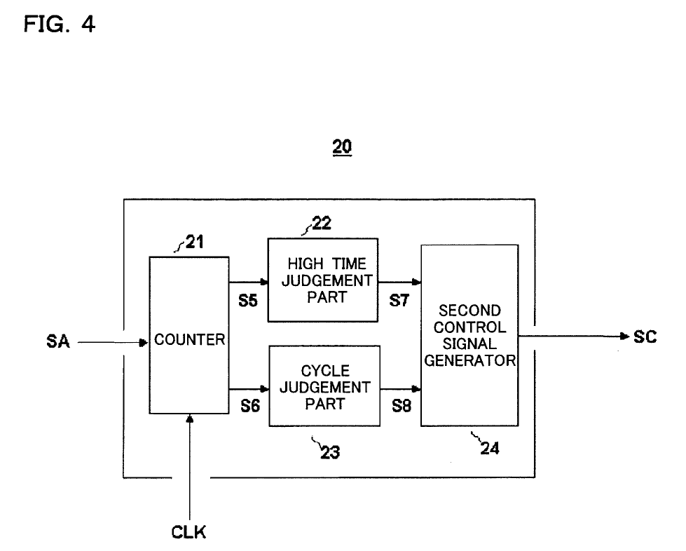

FIG. 4 is a block diagram illustrating an example of a signal judgment part 20. Thus, the signal judgment part 20 includes a counter 21, a high time judgment part 22, a cycle judgment part 23, and a second control signal generator 24. The first control signal SA supplied from an external device (e.g., the microcomputer 3) and the clock signal CLK provided from the oscillator 40 are provided to the counter 21. The counter 21 counts the first control signal SA provided based on the signal clock CLK, and outputs a high time count signal S5 and a cycle count signal S6.

The counter 21 starts a count triggered by a rising edge of the first control signal SA, detects the next following falling edge and counts the time between both edges, and generates the high time count signal S5. The counter 21 starts a count triggered by a rising edge of the first control signal SA, detects the next following rising edge, and generates the cycle count signal S6.

The high time judgment part 22 calculates a high time of the first control signal SA based on the high time count signal S5, and provides the high time signal S7 to the second control signal generator 24. The cycle judgment part 23 calculates a cycle of the first control signal SA based on the cycle count signal S6, and provides the cycle signal S8 to the second control signal generator 24.

The second control signal generator 24 provides the second control signal SC based on the high time signal S7 and the cycle signal S8. If high time of the high time signal S7 is smaller than 10 μS and a cycle of the cycle signal S8 is smaller than or equal to 0.5 mS (i.e., a frequency of which is 2 kHz), then the second control signal SC becomes a high level. If the condition is not attained, the second control signal SC becomes a low level.

In FIG. 2, the buffer voltage VR is provided to an inverting input terminal (−) of the first comparator 31 from the buffer circuit 11. A reference voltage V2 is provided to the non inverting input terminal (+) of the first comparator 31 from the DC voltage source E2, and an output signal S3 based on a comparison between the buffer voltage VR and the reference voltage V2 is provided as an output.

The buffer voltage VR outputted from the buffer circuit 11 is inputted to an inverting input terminal (−) of the second comparator 32. A reference voltage V3 outputted from the DC voltage source E3 is inputted to a non inverting input terminal (+) of the second comparator 32, an output signal S4 is outputted based on a comparison between the buffer voltage VR and the reference voltage V3.

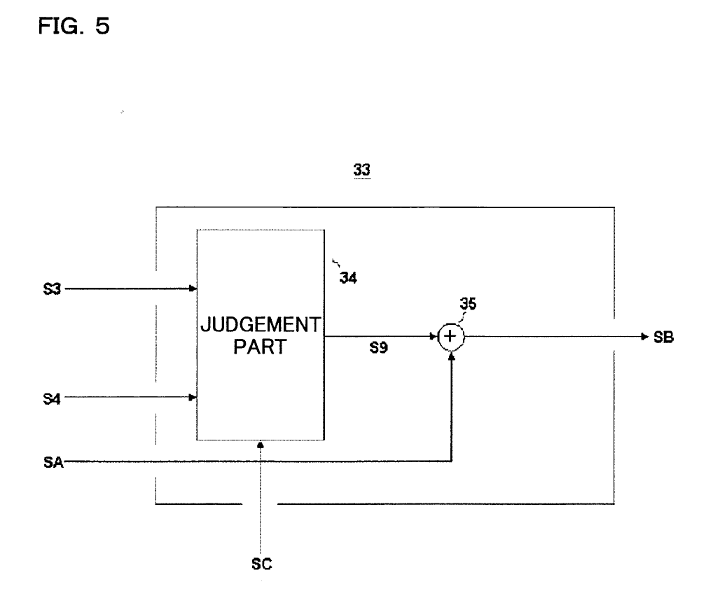

FIG. 5 is a block diagram illustrating a construction example of a switching pulse adjustment part 33, including a judgment part 34 and the adder 35. An output signal S3 outputted from a first comparator 31, an output signal S4 outputted from a second comparator 32, and a second control signal SC outputted a signal judgment part 20 are inputted to the judgment part 34. The judgment part 34 outputs an adjustment signal S9 based on the output signal S4 and the output signal S5 and the second control signal SC. A adjustment signal S9 and a first control signal SA are inputted to the adder 35, and the adder 35 outputs a switching control signal SB, which represents a sum of the first control signal SA and the adjustment signal S9.

The judgment part 34 determines whether or not to provide adjustment signal S9 based on the second control signal SC. For example, the judgment part 34 determines to provide the adjustment signal S9 if the second control signal SC is at a high level, and determines not to provide the adjustment signal S9 regardless of values of the output signals S4 and S3 if the second control signal SC is at a low level.

The judgment part 34 sets the adjustment signal S9 in accordance with values of the output signals S4 and S3. Thus, the judgment part 34 adds a pulse signal of the first control signal SA and the adjustment signal S9 (the adjustment signal S9 is based on the output signals S4 and S3).

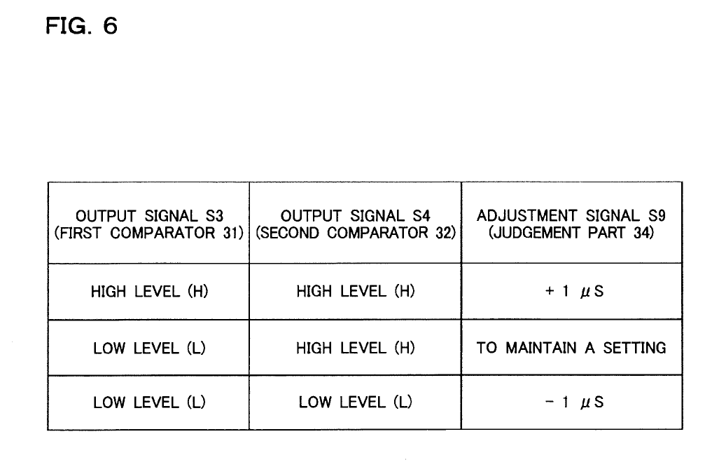

FIG. 6 is a truth table used for an adjustment of the switching pulse adjustment part 33 in accordance with the disclosure. If the output signal S3 from the first comparator 31 is at a high level (H) and the output signal S4 from the second comparator 32 is at a high level, the judgment part 34 provides the adjustment signal S9 to increase the ON time of the first control signal SA. For example, if the first control signal SA is a PWM signal and has a frequency of 25 kHz and a cycle of 40 μS, the ON time becomes 0.4 μS if the duty ratio is 1%. The adjustment signal S9 increases the ON time for 1 μLES, the ON time of the third control signal SB outputted from the adder 35 becomes 1.4 μS for one cycle.

In addition, for example, if the reference voltage V2 provided to the non inverting input terminal (+) of the first comparator 31 is 0.7 V, a condition that the buffer voltage VR smaller than 0.7V inputted to an inverting input terminal (−) is a condition that the output signal S3 becomes a high level. As with the output signal S3, for example, if the reference voltage V3 inputted to a non inverting input terminal (+) of the second comparator 32 is 0.9 V, a condition that the buffer voltage VR smaller than 0.9V inputted to a inverting input terminal (−) is a condition that the output signal S4 becomes a high level. Thus, a situation in which the buffer voltage VR is smaller than 0.7V (i.e., the output signals S3 and S4 are at a high level) meets the requirements.

If the output signal S3 provided from the first comparator 31 is at a low level (L) and the output signal S4 provided from the second comparator 32 is at a high level (H), the judgment part 34 outputs the adjustment signal S9 to maintain a setting which adjusts the ON time of the first control signal SA. For example, if the first control signal SA is a PWM signal and has a frequency of 25 kHz, and a cycle of 40 μS, the ON time becomes 0.4 μS if a duty ratio is 1%, and if a previous adjustment signal S9 increases the ON time for 1 μS, since the adjustment signal S9 is a signal to maintain a setting for the ON time, the ON time of the third control signal SB outputted from the adder 35 becomes 1.4 μS for one cycle.

In addition, for example, if the reference voltage V2 inputted to the non inverting input terminal (+) of the first comparator 31 is 0.7 V, a condition that a buffer voltage VR greater than 0.7V inputted to the inverting input terminal (−) is a condition that the output signal S3 becomes a low level. As with the output signal S3, for example, if the reference voltage V3 inputted to the non inverting input terminal (+) of the second comparator 32 is 0.9 V, a condition that the buffer voltage VR smaller than 0.9V inputted to the inverting input terminal (−) is a condition that the output signal S4 becomes a high level. Thus, a situation in which the buffer voltage VR is greater than 0.7V and smaller than 0.9V (i.e., the output signal S3 is a low level and the output signal S4 is a high level) meets the requirements.

If the output signal S3 from the first comparator 31 is at a low level (L) and the output signal S4 from the second comparator 32 is at a low level (L), the judgment part 34 outputs the adjustment signal S9 to decrease the ON time of the first control signal SA. For example, if the first control signal SA is a PWM signal and has a frequency of 25 kHz, and a cycle of 40 μS, the ON time becomes 0.4 μS if a duty ratio is 1%, and if a previous adjustment signal S9 increases the ON time for 1.0 μS, since the adjustment signal S9 of this time is a signal to decrease the ON time for 1.0 μS, as a result the ON time of the third control signal SB outputted from the adder 35 becomes 0.4 μS for one cycle.

In addition, for example, if the reference voltage V2 inputted to the non inverting input terminal (+) of the first comparator 31 is 0.7 V, a condition that a buffer voltage VR greater than 0.7V inputted to the inverting input terminal (−) is condition that the output signal S3 becomes a low level. As with the output signal S3, for example, if the reference voltage V3 inputted to the non inverting input terminal (+) of the second comparator 32 is 0.9 V, a condition that a buffer voltage VR greater than 0.9V inputted to the inverting input terminal (−) is a condition the output signal S4 becomes a low level. Thus, a situation in which the buffer voltage VR is greater than 0.9V (i.e., the output signal S3 is a low level and the output signal S4 is a low level) meets the requirements.

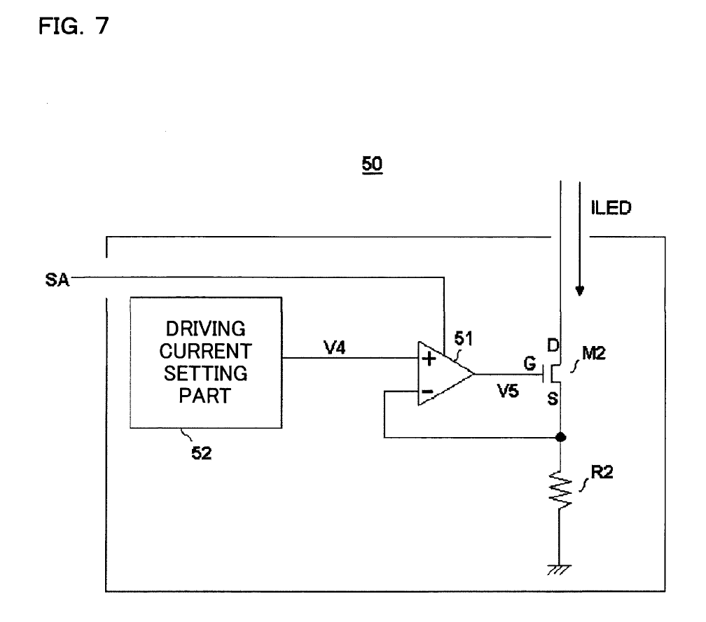

FIG. 7 is a circuit diagram illustrating a construction example of a current driving circuit 50 in accordance with the disclosure.

As illustrated in FIG. 7, as a measure to set a driving current for the light emitting diode rows LED1 to LED6, the current driving circuit 50 of this embodiment includes a NMOS FET M2, a resistor R2, an amplifier 51, and a driving current setting part 52.

A drain terminal D of the NMOS FET M2 is connected to a cathode of the light emitting diode row LED1. A source terminal S of the NMOS FET M2 is connected to a ground terminal via the resistor R2. A non inverting input terminal (+) of the amplifier 51 is connected to the driving current setting part 52, and an inverting input terminal (−) of the amplifier 51 is connected to a source terminal S of the NMOS FET M2. An output terminal of the amplifier 51 is connected to a gate terminal G of the NMOS FET M2. The first control signal SA is inputted to the amplifier 51 as a signal to control the LED driving current ILED.

The driving current setting part 52 supplies the driving voltage V4 to the amplifier 51 in response to the LED driving current ILED. The amplifier 51 supplies a control voltage V5 to a gate terminal G of the NMOS FET M2 to equalize a connection node (a connection node of a source terminal S of the NMOS FET M2 and the resistor R2) with the driving the voltage V4.

With respect to the light emitting diode rows LED2 to LED6, the same circuit as above is provided.

An explanation about the timing chart of the LED driving device 200 is described below.

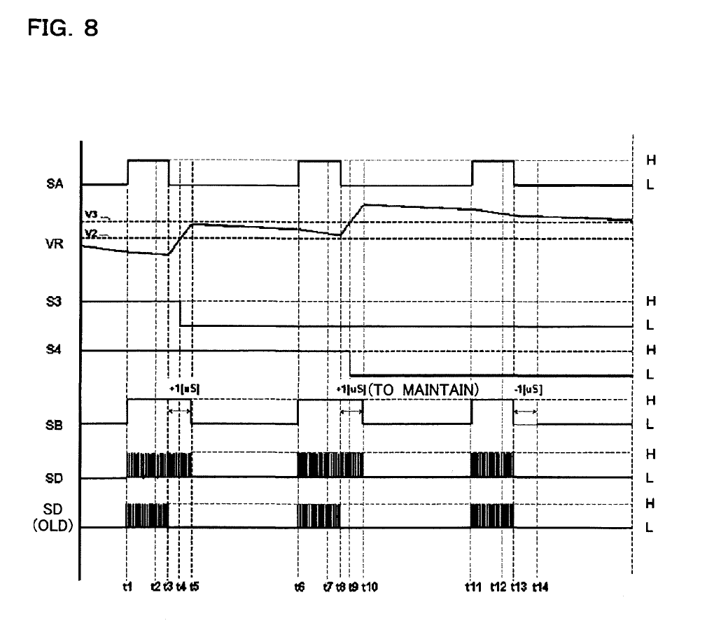

FIG. 8 is a timing chart that relates to control of the LED driving device 200. In FIG. 8, from the top of the diagram, the first control signal SA, the buffer voltage VR, the output signal S3, the output signal S4, the third control signal SB, the switching signal SD, and the conventional switching signal SD are illustrated for a situation not using a LED driving device in accordance with the disclosure.

The first control signal SA is a pulse signal supplied from an electrical device (e.g., the microcomputer 3). For example, the first control signal SA is at a low level L (illustrated as L in FIG. 8) until time t1, and rises to a high level H from a low level L at time t1. Then falls to a low level L from a high level H at time t3. And then rises to a high level H from a low level L at time t6 again, then falls to a low level L from a high level H at time t9. And then rises to a high level H from a low level L at time t10, then falls to a low level L from a high level H at time t12. This pulse signal is a signal to meet a condition of the second control signal SC inputted to the switching pulse adjustment circuit 30 becomes a high level H (i.e., a signal for the judgment part 34 to work is inputted). Also, during the third control signal SB is inputted to the switching controller 15 as a high level H, an explanation will be described based on an assumption that the PWM signal S1 inputted to the switching controller 15 is a at high level H at all times.

An explanation until time t1 is described below. The first control signal SA becomes a low level L, and the buffer voltage VR drops by degree on account of halting the step up operation of the LED driving device 200. Then, as the buffer voltage VR is smaller than the reference voltage V2 and V3, the output signals S3 and S4 outputted from the first comparator 31 and the second comparator 32 become a high level H. As the first control signal SA is at a low level L, the third control signal SB becomes a low level L. In addition, as for the third control signal SB until time t1, the signal SB equals to a signal nothing is adjusted to the first control signal SA. Thus, the third control signal SB equals to a control pulse signal until time t1. The switching signal SD is not generated when the third control signal SB is at a low level L. The conventional switching signal SD is generated based on the first control signal SA, so the signal is not generated when the first control signal SA is at a low level L.

An explanation from time t1 to t3 is described below. The first control signal SA becomes a high level H from time t1 to t3. Come along with that, although the LED driving device 200 starts a step up operation, as the ON time of the output transistor M1 is short to perform a step up operation and a coil current Icoil is small, sufficient electric power is difficult to obtain, then the buffer voltage VR drops by degree from time t1 to time t3. The buffer voltage VR is smaller than the reference voltages V2 and V3 from time t1 to t3, and the output signals S3 and S4 outputted from the first comparator 31 and the second comparator 32 become a high level H. The first control signal SA is at a high level H from time t1 to t3, and the third control signal SB becomes a high level H. The third control signal SB is at a high level H from time t1 to t3, and the switching signal SD is generated. The conventional switching signal SD also is generated when the first control signal SA is at a high level H.

An explanation from time t3 to t4 is described below. The first control signal SA becomes a low level L from time t3 to t4. Come along with that, the conventional switching signal SD is not generated from time t3 to t4. Because the LED driving device 200 in accordance with the disclosure includes the switching pulse adjustment circuit 30, when output signals S3 and S4 are at a high level H at time t2, the judgment part 34 outputs an adjustment signal S9 which increases the ON time (i.e., the high level period H) of the first control signal SA against the first control signal SA. Thus, the third control signal SB is at a high level H from time t3 to t4, also the switching signal SD is generated from time t3 to t4, and the LED driving device 200 performs a step up operation. Thus, the buffer voltage VR rises by degree from time t3 to t4. In addition, with respect to the third control signal SB in FIG. 8, the increased period (=1 μS) is equivalent from time t3 to t5.

An explanation from time t4 to t5 is described below. The first control signal SA becomes a low level L from time t4 to t5. Come along with that, the conventional switching signal SD is not generated from time t4 to t5. Because the LED driving device 200 in accordance with the disclosure includes the switching pulse adjustment circuit 30, when output signals S3 and S4 are at a high level H at time t2, the judgment part 34 provides an adjustment signal S9 which increases the ON time (i.e., the high level period H) of the first control signal SA against the first control signal SA. Thus, the third control signal SB is at a high level H from time t4 to t5, also the switching signal SD is generated from time t4 to t5, and the LED driving device 200 performs a step up operation. Thus the buffer voltage VR rises by degree from time t4 to t5. The buffer voltage VR is greater than the reference voltage V2 from time t4 to t5 and smaller than the reference voltage V3, then the output signal S3 becomes a low level L, and the output signal S4 becomes a high level H.

An explanation from time t5 to t6 is described below. The first control signal SA becomes a low level L from time t5 to t6. As the increased time is lapsed at t5 (1 μS), the third control signal SB falls to a low level L and is maintained at a low level L until time t6. The third control signal SB is at a low level L from time t5 to t6, and the pulse signal is not generated with respect to the switching signal SD. Come along with that, the LED driving device 200 halts the step up operation of the LED driving device 200, and the buffer voltage VR dropsby degree. Then the buffer voltage VR becomes greater than the reference voltage V2 and smaller than the reference voltage V3 from time t5 to t6, the output signal S3 becomes a low level L, and the output signal S4 becomes a high level H. The conventional switching signal SD is generated based on the first control signal SA, and the signal is not generated when the first control signal SA is at a low level L.

An explanation from time t6 to t8 is described below. The first control signal SA becomes a high level H from time t6 to t8. Come along with that, although the LED driving device 200 starts a step up operation, as the ON time of the output transistor M1 is short to perform a step up operation and a coil current Icoil is small, sufficient electric power is difficult to obtain then the buffer voltage VR drops from time t6 to time t8. The buffer voltage VR is greater than the reference voltage V2 and smaller than the reference voltage V3 from time t6 to t8. The output signal S3 becomes a low level L, and the output signal S4 becomes a high level H. The first control signal SA is at a high level H from time t6 to t8, and the third control signal SB becomes a high level H. The third control signal SB is at a high level H from time t6 to t8, and the switching signal SD is generated. The conventional switching signal SD is generated when the first control signal SA is at a high level H.

An explanation from time t8 to t9 is described below. The first control signal SA becomes a low level L from time t8 to t9. The conventional switching signal SD is not generated from time t8 to t9. Because the LED driving device 200 in accordance with the disclosure includes the switching pulse adjustment circuit 30, based on the level of output signals S3 and S4 at time t7, the judgment part 34 operates to maintain a current condition of the ON time (i.e., the high level period H) of the first control signal SA. Thus, the judgment part 34 is set at time t2 to output an adjustment signal S9 to increase the ON time of the first control signal SA for 1 μS, and then continue to outputs the adjustment signal S9 of the same condition. Therefore, the third control signal SB becomes a high level H from time t8 to t9, the switching signal SD is generated from time t8 to t9, and the LED driving device 200 performs a step up operation. Thus, the buffer voltage VR rises by degree from time t8 to t9. In addition, with respect to the third control signal SB in FIG. 8, the increased period (=1 μS) is equivalent to from time t8 to t10.

An explanation from time t9 to t10 is described below. The first control signal SA becomes a low level L from time t9 to t10. Come along with that, the conventional switching signal SD is not generated from time t9 to t10. Because the LED driving device 200 in accordance with the disclosure includes the switching pulse adjustment circuit 30, when the output signal S3 is at a low level L and the output signal S4 is at a high level H at time t7, the judgment part 34 outputs an adjustment signal S9 which maintains the previous setting (i.e., a setting at time t2) about the ON time of the first control signal SA. Thus, the third control signal SB outputs a high level H from time t9 to t10, the switching signal SD also is generated from time t9 to time t10, and the LED driving device 200 performs step up operation. Thus, the buffer voltage VR rises by degree from time t9 to t10. The buffer voltage VR is greater than the reference voltage V3, and the output signals S3 and S4 become a low level L.

An explanation from time t10 to t11 is described below. After a lapse of 1 μs from t8, the third control signal SB becomes a low level L at time t10 and is maintained at a low level until time tn. The third control signal SB is maintained at a low level during time t10 to t11, and a pulse signal is not generated as the switching signal SD. Come along with that, the LED driving device 200 stops the step up operation, and the buffer voltage VR drops by degree. The buffer voltage VR is higher than the reference voltage V3 from time t10 to t11, and the output signals S3 and S4 become a low level L. The conventional switching signal SD is generated based on the first control signal SA, and the signal is not generated when the first control signal SA is at a low level L.

An explanation from time t11 to t13 is described below. The first control signal SA becomes a high level H from time t11 to t13. Come along with that, although the LED driving device 200 starts a step up operation, as the ON time of the output transistor M1 is short to perform a step up operation and a coil current Icoil is small, sufficient electric power is difficult to obtain, then the buffer voltage VR drops by degree from time t11 to t13. The buffer voltage VR is greater than the reference voltage V3 from time t11 to t13, and the output signals S3 and S4 become a low level L. The first control signal SA is at a high level H from time t11 to t13, and the third control signal SB becomes a high level H. The third control signal SB is at a high level H from time t11 to t13, and the switching signal SD is generated. The conventional switching signal SD also is generated when the first control signal SA is at a high level H.

An explanation from time t13 to t14 is described below. The first control signal SA becomes a low level L from time t13 to t14. Come along with that, the conventional switching signal SD is not generated from time t13 to t14. The LED driving device 200 in accordance with the disclosure includes the switching pulse adjustment circuit 30, when both the output signals S3 and S4 become a low level L at time t12, the judgment part 34 operates to decrease the ON time of the first control signal SA. The judgment part 34 is set at time t7 to increase the ON time of the first control signal SA for 1 μS. Thus, increasing of the ON time for 1 μS is decreased for 1 μS, the adjustment signal S9 is provided without increasing or decreasing for the ON time. The third control signal SB becomes a low level at time t13, then the switching signal SD is not generated at time t13. Thus the LED driving device 200 stops the step up operation, the buffer voltage VR drops by degree from time t13 to t14. The time t13 to t14 is equivalent to a decreased 1 μs period of the third control signal SB in FIG. 8.

Thus, the LED driving device or an electrical device using the LED driving device makes it possible to control an output voltage without a voltage drop if the ON time of the PWM signal to drive a LED becomes shorter. Also by using a frequency which exceeds an audio frequency for a PWM signal, ear noise occurring at a print circuit board (i.e., a print circuit board to install the LED driving device or an electrical apparatus) can be prevented.

With respect to the timing chart in the foregoing explanation, the adjustment signal S9 provided from the judgment part 34 is determined based on the output signals S3 and S4 at timings t2 and t7 and t12. However, in some implementations, output signals S3 and S4 based on other timings can be used for the determination.

A setting for the adjustment signal S9 provided from the judgment part 34 is determined by adding an increment/decrement value for adjusting the ON time to an increment/decrement value determined by the previous setting. Thus, an increment/decrement value for the ON time set at time t7 is determined by adding a value to an increment/decrement value for the ON time set at time t2. But an increment/decrement value for the ON time can be determined regardless of the previous setting. Therefore, by not adding current increment/decrement value to the previous increment/decrement value, the current increment/decrement value can be used directly to the adjustment signal S9.

Technical characteristics of some implementations disclosed in the description are summarized below.

In some implementations, a LED driving device includes an output transistor to convert an inputted voltage to a predetermined output voltage and to supply the output voltage to a LED, a signal judgment part to generate a second control signal based on a first control signal of a PWM signal, a switching pulse adjustment circuit to generate a third control signal, and an output control circuit to generate a switching signal supplied to the output transistor based on the third control signal and the feedback voltage. The third control signal is an adjusted signal of the ON time of the first control signal, based on a feedback voltage according to a voltage drop of the LED, and based on the second control signal

This implementation makes it possible to adjust the ON time relatively easily in the LED driving device by using the switching pulse adjustment circuit, even if the ON time of the first control signal is short. Also, the implementation makes it possible to judge whether or not to adjust the ON time of the control signal provided from outside the LED driving device by including the signal judgment part.

In some implementations, the output control circuit includes a buffer circuit to output the feedback voltage as a buffer voltage, an error amplifier to generate an error voltage signal based on the buffer voltage and a first reference voltage, a PWM comparator to generate a PWM signal by comparing the error voltage signal and a triangle wave voltage signal, and a switching controller to generate the switching signal based on the PWM signal and the third control signal.

This implementation makes it possible to generate a switching pulse signal based on the switching pulse adjustment signal, which is an adjusted signal of the ON time of the first control signal. Then the output voltage can be maintained relatively easily.

In some implementations, the switching pulse adjustment circuit includes a first comparator to generate a first output signal based on the buffer voltage and the second reference voltage, a second comparator to generate a second output signal based on the buffer voltage and the second reference voltage, and a switching pulse adjustment part to generate the third control signal. The third control signal is an adjusted signal of the ON time of the first control signal, based on the first output signal, the second output signal, and the second control signal.

In this implementation, by comparing the buffer voltage with the reference voltage, a switching pulse adjustment signal (i.e., a signal, the ON time of which is increased or decreased) can be generated based on the comparison result.

In some implementations, the switching pulse adjustment part includes a judgment part to generate an adjustment signal to adjust the ON time of the first control signal, based on the first output signal, the second output signal, and the second control signal, and an adder to generate the third control signal, which is an adjusted signal of the ON time of the first control signal, based on the adjustment signal.

In this implementation, owing to a comparison result between the buffer voltage and the reference voltage can be used to generate a switching pulse control signal (i.e., a signal, the ON time of which is increased or decreased).

In some implementations, the LED driving device includes an output transistor to convert an inputted voltage to a predetermined output voltage and supplying the output voltage to a LED, a signal judgment part to generate a second control signal based on a first control signal of a PWM signal, a switching pulse adjustment circuit to generate a third control signal, an output control circuit to generate a switching signal supplied to the output transistor based on the third control signal and the feedback voltage, and a current driving circuit to supply a driving current to the LED based on the first control signal. The third control signal is an adjusted signal of the ON time of the first control signal, based on a feedback voltage according to a voltage drop of the LED, and based on the second control signal.

In this implementation, even if the ON time of the first control signal is short, by using the switching pulse adjustment circuit, the ON time can be adjusted relatively easily in the LED driving device. Also by including the signal judgment part, the LED driving device can determine whether or not to adjust the ON time of the control signal provided from outside of the LED driving device. Furthermore, the first control signal can be used to control the current driving circuit.

In some implementations, the electrical apparatus includes, a DC voltage source to generate an input voltage, a microcomputer to output the first control signal, a LED driving device to generate a predetermined output voltage and a driving current based on the first control signal and the input voltage, and a liquid crystal display comprising a LED to which the output voltage and the driving current outputted from the LED driving device are inputted.

In this implementation, even if the ON time of the first control signal is short, by using a switching pulse adjustment circuit, the ON time can be adjusted relatively easily in the LED driving device. Also by including the signal judgment part, the LED driving device can determine whether or not to adjust the ON time of the control signal provided from outside of the LED driving device. Furthermore, the first control signal can be used to control the current driving circuit provided from outside of the current driving circuit.

As mentioned above, as for the LED driving device disclosed in the description and an electrical apparatus using the LED driving device, even if the ON time of a PWM signal to drive a LED becomes short, the LED can be controlled without voltage drop of the output voltage. Also, by using a frequency which exceeds an audio frequency for a PWM signal, ear noise occurring at a print circuit board (i.e., a print circuit board to install the LED driving device or an electrical apparatus) can be prevented.

The LED driving device disclosed in this description can be used as a driving device to drive a LED backlight of a middle sized LCD panel, industrial applicable ways can be expected highly.

It is to be understood that changes and variations may be made without departing from the spirit or scope of the disclosure.

For example, in the above embodiment, a step up switching regulator is used for the LED driving device 200, construction of the disclosure is not restricted to the description, a step down switching regulator or an inverting switching regulator can be used.

Therefore, it is to be understood that all changes and variations without departing from the spirit or scope of the disclosure can be included to the appended claims, and other implementations are within the scope of the claims.

### LIST OF REFERENCE NUMERALS

1 electrical apparatus
2 DC voltage source
3 microcomputer
4 liquid crystal display
10 output control circuit
11 buffer circuit
12 error amplifier
13 PWM comparator
14, 40 oscillator
15 switching controller
20 signal judgement part
21 counter
22 high time judgement part
23 cycle judgement part
24 second control signal generator
30 switching pulse adjustment circuit
31 first comparator
32 second comparator
33 switching pulse adjustment part
34 judgement part
35 adder
50 current driving circuit
51 amplifier
52 driving current setting part
100 LED driving IC
200 LED driving device
BL backlight
C1 capacitor
D1 diode
L1 inductor
LED1 to LED6 light emitting diode row
M1 output transistor
M2 N type field effect transistor
R1, R2 resistor
T1 to T9 external terminal

What is claimed is:

1. A LED driving device comprising:
an output transistor to convert an inputted voltage to a predetermined output voltage and to supply the output voltage to a LED;
a signal judgment part to generate a second control signal based on a first control signal of a PWM signal;
a switching pulse adjustment circuit to generate a third control signal, which is an adjusted signal of an ON time of the first control signal, based on a feedback voltage according to a voltage drop of the LED, and based on the second control signal; and
an output control circuit to generate a switching signal supplied to the output transistor based on the third control signal and the feedback voltage.

2. The LED driving device according to claim 1, wherein the output control circuit comprises:
a buffer circuit to output the feedback voltage as a buffer voltage;
an error amplifier to generate an error voltage signal based on the buffer voltage and a first reference voltage;
a PWM comparator to generate a PWM signal by comparing the error voltage signal and a triangle wave voltage signal; and
a switching controller to generate the switching signal based on the PWM signal and the third control signal.

3. The driving device according to claim 2, wherein the buffer circuit outputs the lowest voltage as a buffer voltage among the multiple feed back voltages detected from the ground terminal, if the LED is connected to multiple LEDs connected in parallel.

4. The LED driving device according to claim 2, wherein the switching pulse adjustment circuit comprises:
a first comparator to generate a first output signal based on the buffer voltage and the second reference voltage;
a second comparator to generate a second output signal based on the buffer voltage and the second reference voltage; and
a switching pulse adjustment part to generate the third control signal, which is an adjusted signal of an ON time of the first control signal, based on the first output signal, the second output signal, and the second control signal.

5. The LED driving device according to claim 4, wherein the switching pulse adjustment part comprises:
a judgment part to generate an adjustment signal to adjust an ON time of the first control signal, based on the first output signal, the second output signal, and the second control signal; and
an adder to generate the third control signal, which is an adjusted signal of an ON time of the first control signal, based on the adjustment signal.

6. A LED driving device comprising:
an output transistor to convert an input voltage to a predetermined output voltage and to supply the output voltage to a LED;
a signal judgment part to generate a second control signal based on a first control signal of a PWM signal;
a switching pulse adjustment circuit to generate a third control signal, which is an adjusted signal of an ON time of the first control signal, based on a feedback voltage according to a voltage drop of the LED, and based on the second control signal;
an output control circuit to generate a switching signal supplied to the output transistor based on the third control signal and the feedback voltage; and
a current driving circuit to supply a driving current to the LED based on the first control signal.

7. The LED driving device according to claim 6, wherein the output control circuit comprises:
a buffer circuit to output the feedback voltage as a buffer voltage;
an error amplifier to generate an error voltage signal based on the buffer voltage and a first reference voltage;
a PWM comparator to generate a PWM signal by comparing the error voltage signal and a triangle wave voltage signal; and
a switching controller to generate the switching signal based on the PWM signal and the third control signal.

8. The LED driving device according to claim 7, wherein the buffer circuit outputs a buffer voltage in response to the lowest voltage among multiple input feedback voltages, if the LED is connected to multiple LEDs connected in parallel.

9. The LED driving device according to claim 7, wherein the switching pulse adjustment circuit comprises:
a first comparator to generate a first output signal based on the buffer voltage and the second reference voltage;
a second comparator to generate a second output signal based on the buffer voltage and the second reference voltage; and
a switching pulse adjustment part to generate the third control signal, based on the first output signal, the second output signal, the first control signal, and the second control signal.

10. The LED driving device according to claim 7, wherein the switching pulse adjustment part comprises:
a judgment part to generate an adjustment signal based on the first output signal, the second output signal, and the second control signal; and
an adder to generate the third control signal, which is an adjusted signal of an ON time of the first control signal, based on the adjustment signal.

11. An electrical apparatus comprising:
a DC voltage source to generate an input voltage;
a microcomputer to output a first control signal;
a LED driving device to generate a predetermined output voltage and a driving current based on the first control signal and the input voltage; and
a liquid crystal display comprising a LED to which the output voltage and the driving current outputted from the LED driving device are inputted;
wherein the LED driving device comprises:
an output transistor to convert an input voltage to a predetermined output voltage and to supply the output voltage to the LED;
a signal judgment part to generate a second control signal based on the first control signal of a PWM signal;
a switching pulse adjustment circuit to generate a third control signal, which is an adjusted signal of an ON time of the first control signal, based on a feedback voltage according to a voltage drop of the LED, and based on the second control signal;
an output control circuit to generate a switching signal supplied to the output transistor based on the third control signal and the feedback voltage; and
a current driving circuit to supply a driving current to the LED based on the first control signal.

12. The LED driving device according to claim 3, wherein the switching pulse adjustment circuit comprises:
a first comparator to generate a first output signal based on the buffer voltage and the second reference voltage;
a second comparator to generate a second output signal based on the buffer voltage and the second reference voltage; and
a switching pulse adjustment part to generate the third control signal, based on the first output signal, the second output signal, the first control signal, and the second control signal.

13. The LED driving device according to claim 12, wherein the switching pulse adjustment part comprises:
a judgment part to generate an adjustment signal to adjust an ON time of the first control signal, based on the first output signal, the second output signal, and the second control signal; and
an adder to generate the third control signal, which is an adjusted signal of an ON time of the first control signal, based on the adjustment signal.

14. The LED driving device according to claim 8, wherein the switching pulse adjustment circuit comprises:
a first comparator to generate a first output signal based on the buffer voltage and the second reference voltage;
a second comparator to generate a second output signal based on the buffer voltage and the second reference voltage; and
a switching pulse adjustment part to generate the third control signal, based on the first output signal, the second output signal, the first control signal, and the second control signal.

15. The LED driving device according to claim 14, wherein the switching pulse adjustment part comprises:
a judgment part to generate an adjustment signal based on the first output signal, the second output signal, and the second control signal; and
an adder to generate the third control signal, which is an adjusted signal of an ON time of the first control signal, based on the adjustment signal.
